(19) United States
(12) Patent Application Publication
(10) Pub. No.: US 2014/0204520 A1
(43) Pub. Date: Jul. 24, 2014

(54) ELECTRONIC DEVICE WITH DETACHABLE KEYBOARD

(71) Applicants: HON HAI PRECISION INDUSTRY CO., LTD., New Taipei (TW); TIANJIN FUNAYUANCHUANG TECHNOLOGY CO., LTD., Tianjin (CN)

(72) Inventors: HO-CHIEN WU, New Taipei (TW); KAI-WEN HSUEH, New Taipei (TW)

(73) Assignees: HON HAI PRECISION INDUSTRY CO., LTD., New Taipei (TW); TIANJIN FUNAYUANCHUANG TECHNOLOGY CO.,LTD., Tianjin (CN)

(21) Appl. No.: 14/146,816

(22) Filed: Jan. 3, 2014

(30) Foreign Application Priority Data
Jan. 22, 2013 (CN) 2013100229548

(51) Int. Cl. G06F 1/16

(52) U.S. Cl. CPC G06F 1/1669
USPC 361/679.17

(57) ABSTRACT

An electronic device includes a base and a keyboard module detachably mounted on the base. The keyboard module includes a first side and a second side. The first side includes a first unit. The second side includes a second unit. The keyboard module is mounted on the base in different directions to expose the first unit or the second unit.

### BACKGROUND

1. Technical Field

The disclosure generally relates to electronic devices, and more particularly to an electronic device which has a detachable keyboard.

2. Description of Related Art

Electronic devices, such as notebook computers, are widely used. The notebook computers are often equipped with keyboards for inputting information. The keyboard is secured on the notebook computer. When the keyboard needs to be replaced, it may be inconvenient to detach the keyboard from the notebook computer.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device with a detachable keyboard.

FIG. 2 is another exploded, isometric view of the electronic device of FIG. 1.

FIG. 3 is an assembled view of the electronic device of FIG. 1.

FIG. 4 is an assembled view of the electronic device of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

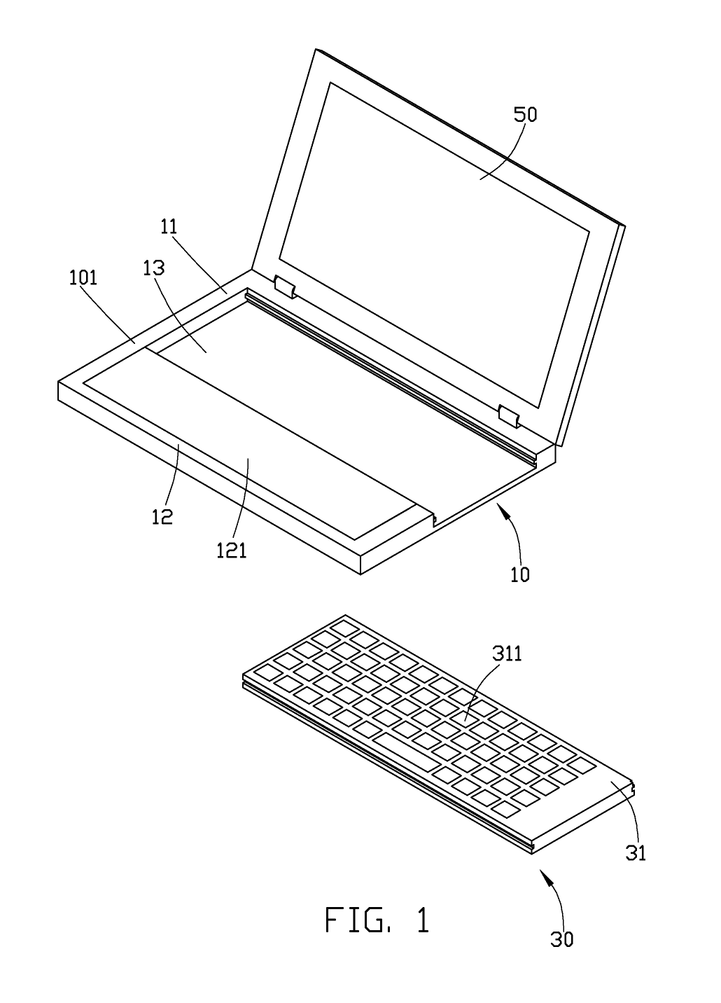

FIG. 1 shows one embodiment of an electronic device. The electronic device includes a base 10, a keyboard module 30, and a display apparatus 50. In one embodiment, the display apparatus 50 is pivotally mounted on the base 10 and electronically connected to the base 10. In the illustrated embodiment, the electronic device is a notebook computer. In another embodiment, the display apparatus 50 can be detached from the base 10 and communicate wirelessly with the base 10.

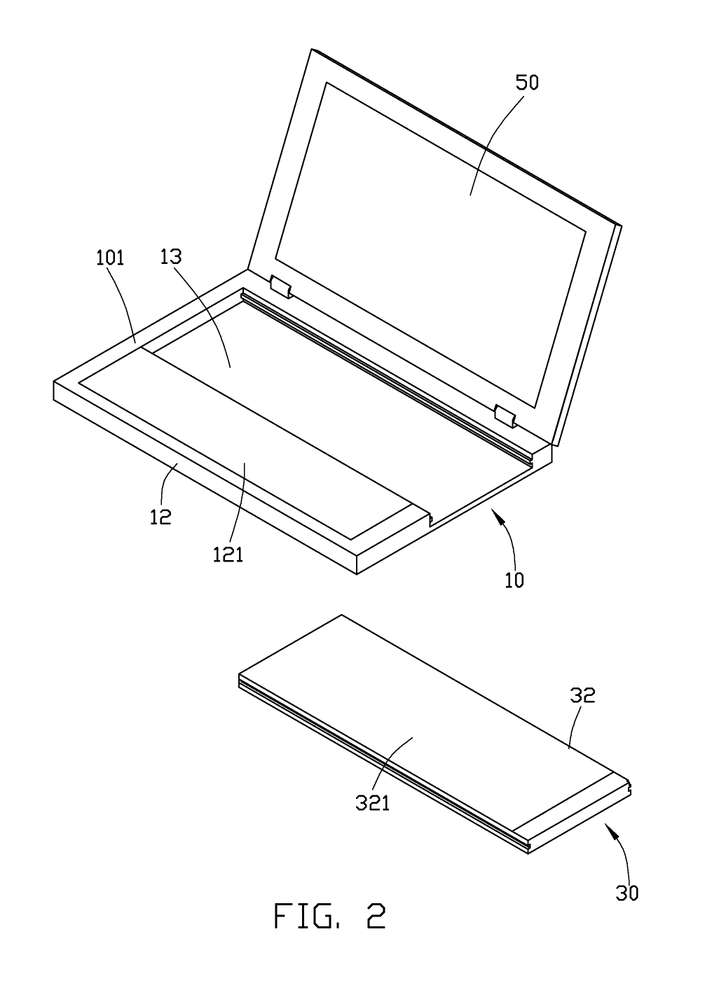

FIGS. 1 and 2 show that the keyboard module 30 is substantially an elongated cube. The keyboard 30 includes a first side 31 and a second side 32 opposite to the first side 31. The first side 31 is parallel to the second side 32. In one embodiment, the first side 31 is a top side of the keyboard module 30, and the second side 32 is a bottom side of the keyboard module 30. A key unit 311, which includes a plurality of keys, is mounted on the first side 31. A function unit 321, which is different from the key unit 311, is mounted on the second side 32. In one embodiment, the function unit 321 is a normal screen or a touch screen, which can receive input.

The base 10 includes a working surface 101. The working surface 101 includes a first area 11 and a second area 12. The first area 11 is located adjacent the display apparatus 50. The first area 11 is sunk to define a receiving space 13, which is adapted to receive the keyboard module 30. A depth of the receiving space 13 is substantially equal to a thickness of the keyboard module 30. The second area 12 includes a touch screen 121.

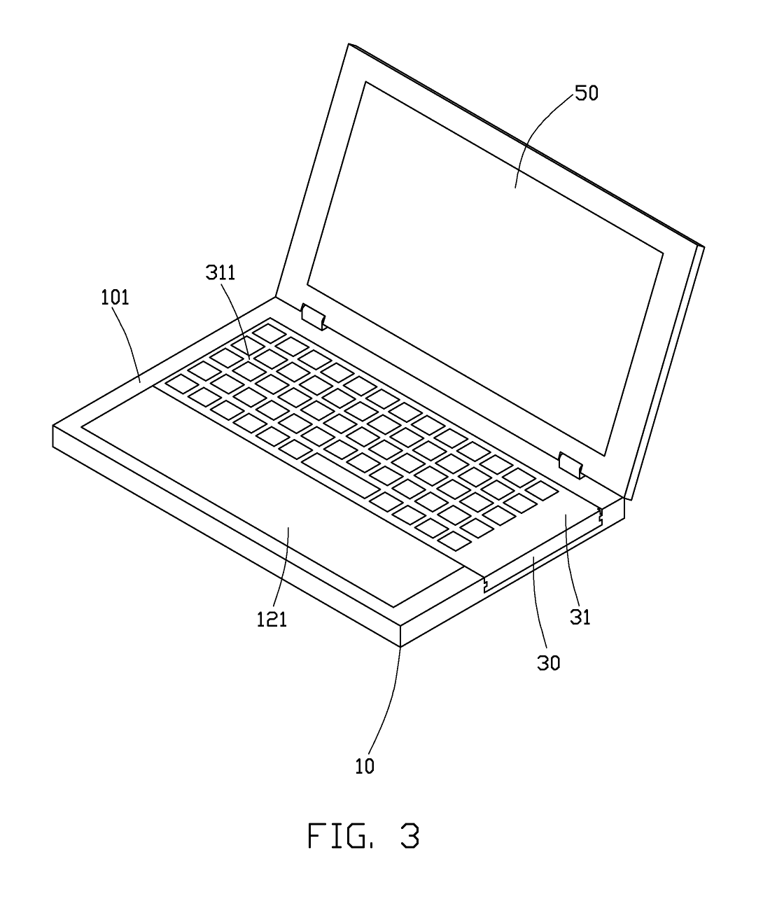

FIGS. 1 and 3 show that use the electronic device in a first manner, the keyboard module 30 is placed into the receiving space 13 to have the first side 31 located above the second side 32. The keyboard 30 is mounted in the base 10 with the key unit 311 exposed on the working surface 101. The keys of the key unit 311 can be pressed to input information to the electronic device. The function unit 312 is located in the receiving space 13 and is manually inaccessible.

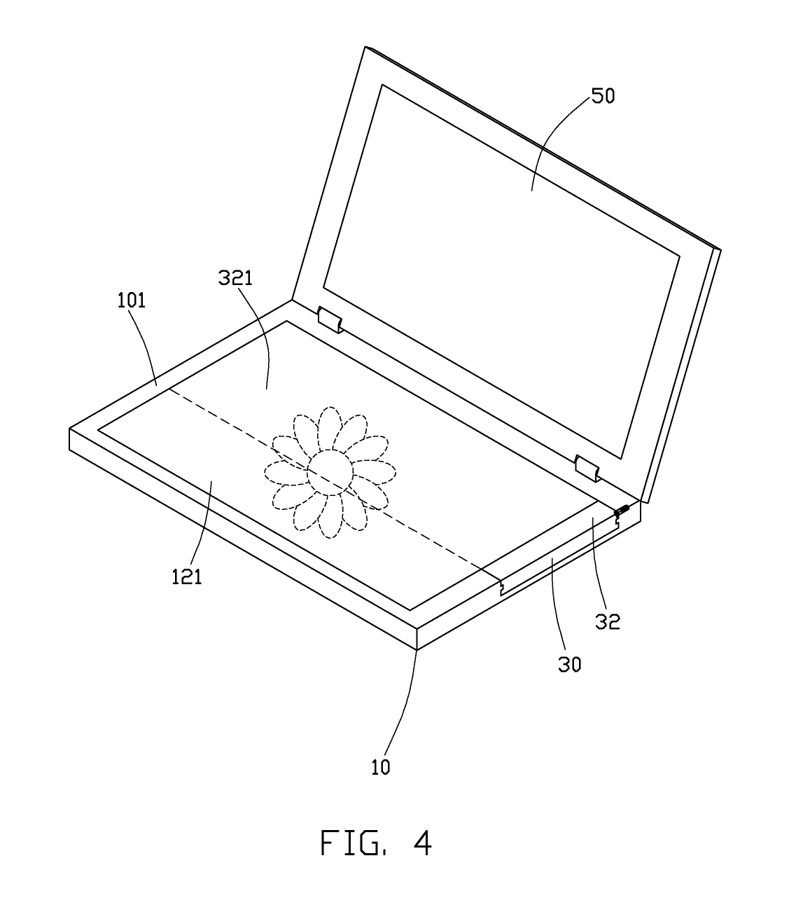

FIGS. 1 and 3 show that use the electronic device in a second manner, the keyboard module 30 is placed into the receiving space 13 to have the second side 32 located above the first side 31. The keyboard 30 is mounted in the base 10 with the function unit 30 exposed on the working surface 101. The function unit 321 can be accessed. The function unit 321 and the touch screen 121 are coplanar. The touch screen of the function unit 321 is aligned to the touch screen 121 combining to form a large touch screen. Therefore, the large touch screen may be conveniently operated, such as depicted in FIG. 4. The key unit 311 is located in the receiving space 13 and is inaccessible.

In another embodiment, the function unit 321 is a tablet computer, which includes a touch screen.

In the disclosed electronic device, sliding rails can be set on either the keyboard module 30 or the receiving space 13, and sliding grooves can be defined in the other one of the keyboard module 30 or the receiving space 13. The sliding rails slide in or out of the sliding groove to mount the keyboard module 30 on the base 10 or for detaching the keyboard module 30 from the base 10.

The keyboard module 30 can have a connector which is connected to the base 10. Further, the keyboard module 30 may include a wireless module for communication with the base 10.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a base; and
a keyboard module detachably mounted on the base, the keyboard module comprising a first side and a second side, the first side comprising a first unit, the second side comprising a second unit, and the keyboard module is configured to be mounted on the base in different directions to expose the first unit or the second unit.

2. The electronic device of claim 1, wherein the first unit or the second unit is alternatively accessible by rotating the keyboard module 180 degrees.

3. The electronic device of claim 1, wherein the first unit is configured to be accommodated inside the base when the second unit is exposed, and the second unit is configured to be accommodated inside the base when the first unit is exposed.

4. The electronic device of claim 1, wherein the base comprises a receiving space, and the keyboard module is configured to be accommodated inside the receiving space.

5. The electronic device of claim 4, wherein a depth of the receiving space is substantially equal to a thickness of the keyboard module.

6. The electronic device of claim 5, wherein the second unit is a first touch screen.

7. The electronic device of claim 6, wherein the base comprises a second touch screen, and the first touch screen and the second touch screen are configured to be combined into one touch screen when the keyboard module is inside the receiving space and the second unit is exposed.

8. The electronic device of claim 1, wherein the first unit is a key unit, and the second unit is a function unit.

9. The electronic device of claim 1, wherein the second unit is a tablet computer, and the tablet computer comprises a touch screen.

10. An electronic device, comprising:
a base defining a working surface;
a keyboard module comprising a first side and a second side, a first unit mounted on the first side, a second unit mounted on the second side, wherein keyboard module is detachably mounted on the base to alternatively expose the first unit or the second unit.

11. The electronic device of claim 10, wherein the first unit is a key unit, and the second unit is a function unit.

12. The electronic device of claim 10, wherein the base comprises a receiving space, and the keyboard module is configured to be accommodated inside the receiving space.

13. The electronic device of claim 10, wherein the second unit is a first touch screen.

14. The electronic device of claim 13, wherein the base comprises a second touch screen, and the first touch screen and the second touch screen are configured to be combined into one touch screen when the keyboard is inside the receiving space and the second unit is exposed.

15. The electronic device of claim 10, wherein the second unit is a tablet computer, the tablet computer comprises a touch screen.

16. A keyboard module, comprising:
a key unit mounted on a top side of the keyboard module; and
a function unit mounted on a bottom side opposite to the top side.

17. The keyboard module of claim 16, wherein the function unit is a screen or a tablet computer.
